(19) United States
(12) Patent Application Publication
(10) Pub. No.: US 2018/0075280 A1
(43) Pub. Date: Mar. 15, 2018

(54) FINGERPRINT DETECTION APPARATUS, MOBILE DEVICE USING THE SAME AND MANUFACTURING METHOD THEREOF

(71) Applicant: Eosmem Corporation, Zhubei City (TW)

(72) Inventor: Jia-Lung Wang, Zhubei City (TW)

(21) Appl. No.: 15/702,245

(22) Filed: Sep. 12, 2017

(30) Foreign Application Priority Data
Sep. 12, 2016 (TW) 105129548

(51) Int. Cl. G06K 9/00

(52) U.S. Cl. CPC G06K 9/00033; G06K 9/0008; G06K 9/00053

(57) ABSTRACT

A fingerprint detection apparatus, a mobile device using the same and a manufacturing method thereof are provided. The fingerprint detection apparatus comprises a substrate, an image sensing integrated circuit (IC), a light emitting circuit, a window layer and a molding material. The image sensing IC is disposed on the substrate. The light emitting circuit is disposed on the substrate and one side of the image sensing IC, and is electrically connected to the image sensing IC. The window layer is disposed on the image sensing IC, wherein light can pass through the window layer and enter the image sensing IC. The molding material surrounds the image sensing IC and blocks a light travelling path between the light emitting circuit and the image sensing IC to prevent the light emitted directly from the light emitting circuit from entering the image sensing IC and enhance the quality of fingerprint identification.

### BACKGROUND OF THE INVENTION

### Field of the Invention

The invention relates to the technology of fingerprint identification, and more particularly to a fingerprint detection apparatus integrated with a light-emitting diode (LED), a mobile device using the same and a manufacturing method thereof, wherein the fingerprint detection apparatus can prevent interference of directly emitted light of an internal LED and allow the light of the LED to enter a finger.

### Description of the Related Art

Modern products are requested to be slim and light, so many separate circuits are integrated into integrated circuits. FIG. 1 is a structure diagram showing a conventional fingerprint input device. Referring to FIG. 1, the conventional fingerprint input device comprises a substrate 100, a two-dimensional image sensor 101 and a LED 102. The LED 102 emits light with a predetermined wavelength to a finger, which reflects scatter light. The two-dimensional image sensor 101 receives the scatter light directly from ridge portions of the finger, and the scatter light scattered by the valley portions of the finger diffuses. However, the light of the LED 102 directly entering the two-dimensional image sensor 101 frequently causes the vague fingerprint captured by the two-dimensional image sensor 101, and causes the failure of the fingerprint identification.

FIG. 2 is a structure diagram showing another conventional fingerprint input device. Referring to FIG. 2, the conventional fingerprint input device comprises the substrate 100, the two-dimensional image sensor 101 and the LED 102, and further comprises a shielding wall 201 for stopping the directly emitted light of the LED 102 from travelling to the two-dimensional image sensor 101. However, the shielding wall 201 cannot be easily manufactured, and tends to be collapsed and damaged.

### SUMMARY OF THE INVENTION

An objective of the invention is to provide a fingerprint detection apparatus, a mobile device using the fingerprint detection apparatus and a manufacturing method of the fingerprint detection apparatus. The fingerprint detection apparatus may be integrated with an LED, which provides the supplemental light to make the fingerprint clearer. In addition, in the LED integrated fingerprint detection apparatus, it is also possible to prevent the light of the LED from directly entering the image sensing IC, and the effect of preventing the crosstalk and interference can be obtained.

In view of this, the invention provides a fingerprint detection apparatus comprising a substrate, an image sensing IC, a light emitting circuit, a window layer and a molding material. The image sensing IC is disposed on the substrate. The light emitting circuit is disposed on the substrate, and one side of the image sensing IC. The light emitting circuit is electrically connected to the image sensing IC. The window layer is disposed on the image sensing IC, and allows light to pass through and enter the image sensing IC. The molding material surrounds the image sensing IC, the light emitting circuit and the window layer. The molding material blocks a light travelling path between the light emitting circuit and the image sensing IC, prevents the light, emitted directly from the light emitting circuit, from entering the image sensing IC, and enhances a quality of fingerprint identification.

The present invention further provides a mobile device. The mobile device includes a control circuit, a display panel, a protective cover and a fingerprint detection apparatus. The display panel is electrically connected to the control circuit. The protective cover is disposed on the display panel. The fingerprint detection apparatus includes a substrate, an image sensing IC, a light emitting circuit, a window layer and a molding material. The image sensing IC is disposed on the substrate. The light emitting circuit is disposed on the substrate and on one side of the image sensing IC and it is electrically connected to the image sensing IC. The window layer is disposed on the image sensing IC, wherein light can pass through the window layer and enter the image sensing IC. The molding material surrounding the image sensing IC and the window layer, wherein the molding material blocks a light travelling path between the light emitting circuit and the image sensing IC to prevent light, emitted directly from the light emitting circuit, from entering the image sensing IC and to enhance a quality of fingerprint identification.

In the fingerprint detection apparatus and the mobile device according to a preferred embodiment of the present invention, the window layer includes a spatial filter. The spatial filter is disposed on the image sensing IC, wherein the spatial filter has multiple neighboring light channels, which restrict an angle of light entering the image sensing IC to prevent scatter light from entering the image sensing IC.

In the fingerprint detection apparatus and the mobile device according to a preferred embodiment of the present invention, the light emitting circuit includes a specific light source emitting circuit which is disposed on one side of the image sensing IC and electrically connected to the image sensing IC. When finger is disposed on the fingerprint detection apparatus, the image sensing IC is for sensing the light which the finger reflects from the specific light source. In another embodiment, the light emitting circuit includes a visible light emitting circuit. The visible light emitting circuit is disposed on one side of the image sensing IC and electrically connected to the image sensing IC. When the fingerprint identification is performed, the visible light emitting circuit emits visible light to make a user obtain a placement position of a finger through the visible light. In another preferred embodiment, the light channels of the spatial filter constitute a two-dimensional array.

In the fingerprint detection apparatus and the mobile device according to a preferred embodiment of the present invention, the fingerprint detection apparatus is packaged by way of system in package (SIP). The image sensing IC is attached to the substrate by a silver paste, and the light emitting circuit is attached to the substrate by a soldering paste. The molding material of the fingerprint detection apparatus includes an epoxy resin covering the image sensing IC, the light emitting circuit and the window layer through a molding process, wherein the window layer and a light-permeable material of the light emitting circuit are exposed through a grinding process, so that when the light emitting circuit is turned on, light can be emitted from a ground surface of the light emitting circuit, and the image sensing IC receives light from a finger through a ground surface of the window layer.

In the fingerprint detection apparatus and the mobile device according to a preferred embodiment of the present invention, the fingerprint detection apparatus is packaged by way of double molding. The image sensing IC is attached to the substrate using a first silver paste. The light emitting circuit is attached to the substrate using a second silver paste. The fingerprint detection apparatus further comprises, on the light emitting circuit, a light-permeable mold covering the light emitting circuit. The molding material of the fingerprint detection apparatus comprises: an epoxy resin covering the image sensing IC and the window layer through a molding process, wherein the window layer is exposed through a grinding process, so that when the light emitting circuit is turned on, light emitted from the light emitting circuit is emitted through the finger and received by the image sensing IC through a ground surface of the window layer.

The present invention further provides a method of manufacturing a fingerprint detection apparatus. The method of manufacturing a fingerprint detection apparatus includes the steps of: providing a substrate; performing a first surface-mount process on light emitting elements; performing a second die attaching process on image sensing ICs which respectively have a window layer, wherein the window layer is disposed on the image sensing IC, wherein light passes through the window layer and enters the image sensing IC; performing a wire bonding process on the image sensing ICs which respectively have the window layer; performing a molding process on the image sensing ICs which respectively have the window layer and the light emitting elements; performing an post mold curing process; performing a grinding process; and performing a dicing process to form independent fingerprint detection apparatuses.

The present invention further provides a method of manufacturing a fingerprint detection apparatus. The method of manufacturing a fingerprint detection apparatus includes the steps of: providing a substrate; performing a first die attaching process on light emitting elements; performing a first wire bonding process on the light emitting elements; performing a first molding process on the light emitting elements; performing a first mold curing process; performing a second die attaching process on image sensing ICs which respectively have a window layer, wherein the window layer is disposed on the image sensing IC, wherein light passes through the window layer and enters the image sensing IC; performing a second wire bonding process on the image sensing ICs which respectively have the window layer; performing a second molding process on the image sensing ICs which respectively have the window layer and the light emitting elements; performing an post mold curing process; performing a grinding process; and performing a dicing process to form independent fingerprint detection apparatuses.

In the fingerprint detection apparatus and the mobile device according to a preferred embodiment of the present invention, the step of forming the image sensing ICs which respectively have the window layer comprises: forming the image sensing ICs on a wafer; forming the window layer on the image sensing ICs using a photoresist; and dicing the wafer to obtain the image sensing ICs which respectively have the window layer.

In the fingerprint detection apparatus and the mobile device according to a preferred embodiment of the present invention, the step of forming the window layer on the image sensing ICs using the photoresist comprises: applying a photoresist layer to the image sensing ICs; performing an exposure development process to form photoresist pillar structures on the image sensing ICs; and performing a baking process on the photoresist pillar structures.

The essence of the invention is to dispose one window layer above the image sensing IC for fingerprint identification. The window layer can allow the light to pass through. Then, the light emitting circuit and the image sensing IC for fingerprint identification are packaged into the same integrated circuit. And thus, the light emitting circuit and the image sensing IC for fingerprint identification are integrated in the same IC. Since the molding material encompasses the image sensing IC for fingerprint identification, a natural light block is formed between the light emitting circuit and the image sensing IC for fingerprint identification. Thus, it is possible to prevent the light of the light emitting circuit from directly entering the image sensing IC for fingerprint identification, so that the read fingerprint becomes clearer.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a structure diagram showing a conventional fingerprint input device.

FIG. 2 is a structure diagram showing another conventional fingerprint input device.

FIG. 3 is a schematic view showing a mobile apparatus according to a preferred embodiment of the invention.

FIG. 4 is a structure diagram showing a fingerprint detection apparatus according to a preferred embodiment of the invention.

FIG. 5 is a schematic view showing an operation of a fingerprint detection apparatus according to a preferred embodiment of the invention.

FIG. 6 is a top view showing a spatial filter 504 of a fingerprint detection apparatus according to a preferred embodiment of the invention.

FIG. 7 is a top view showing a spatial filter 504 of a fingerprint detection apparatus according to a preferred embodiment of the invention.

FIG. 8 is a top view showing a spatial filter 504 of a fingerprint detection apparatus according to a preferred embodiment of the invention.

FIG. 9 is a flow chart showing a manufacturing method of a fingerprint detection apparatus according to a preferred embodiment of the invention.

FIG. 9A is a schematic view showing a step S904 of the manufacturing method of the fingerprint detection apparatus according to a preferred embodiment of the invention.

FIG. 9B is a schematic view showing a step S905 of the manufacturing method of the fingerprint detection apparatus according to a preferred embodiment of the invention.

FIG. 9C is a schematic view showing a step S907 of the manufacturing method of the fingerprint detection apparatus according to a preferred embodiment of the invention.

FIG. 9D is a schematic view showing a step S909 of the manufacturing method of the fingerprint detection apparatus according to a preferred embodiment of the invention.

FIG. 10 is a detailed flow chart showing a step S901 of the manufacturing method of the fingerprint detection apparatus according to a preferred embodiment of the invention.

FIG. 10A is a schematic view showing a step S1001 of the manufacturing method of the fingerprint detection apparatus according to a preferred embodiment of the invention.

FIG. 10B is a schematic view showing a step S1002 of the manufacturing method of the fingerprint detection apparatus according to a preferred embodiment of the invention.

FIG. 10C is a schematic view showing a step S1003 of the manufacturing method of the fingerprint detection apparatus according to a preferred embodiment of the invention.

FIG. 10D is a schematic view showing a step S1005 of the manufacturing method of the fingerprint detection apparatus according to a preferred embodiment of the invention.

FIG. 11 is a structure diagram showing a fingerprint detection apparatus according to a preferred embodiment of the invention.

FIG. 12 is a flow chart showing a manufacturing method of a fingerprint detection apparatus according to a preferred embodiment of the invention.

FIG. 12A is a schematic view showing a step S1204 of the manufacturing method of the fingerprint detection apparatus according to a preferred embodiment of the invention.

FIG. 12B is a schematic view showing a step S1205 of the manufacturing method of the fingerprint detection apparatus according to a preferred embodiment of the invention.

FIG. 12C is a schematic view showing a step S1206 of the manufacturing method of the fingerprint detection apparatus according to a preferred embodiment of the invention.

FIG. 12D is a schematic view showing a step S1208 of the manufacturing method of the fingerprint detection apparatus according to a preferred embodiment of the invention.

FIG. 12E is a schematic view showing a step S1210 of the manufacturing method of the fingerprint detection apparatus according to a preferred embodiment of the invention.

FIG. 12F is a schematic view showing a step S1212 of the manufacturing method of the fingerprint detection apparatus according to a preferred embodiment of the invention.

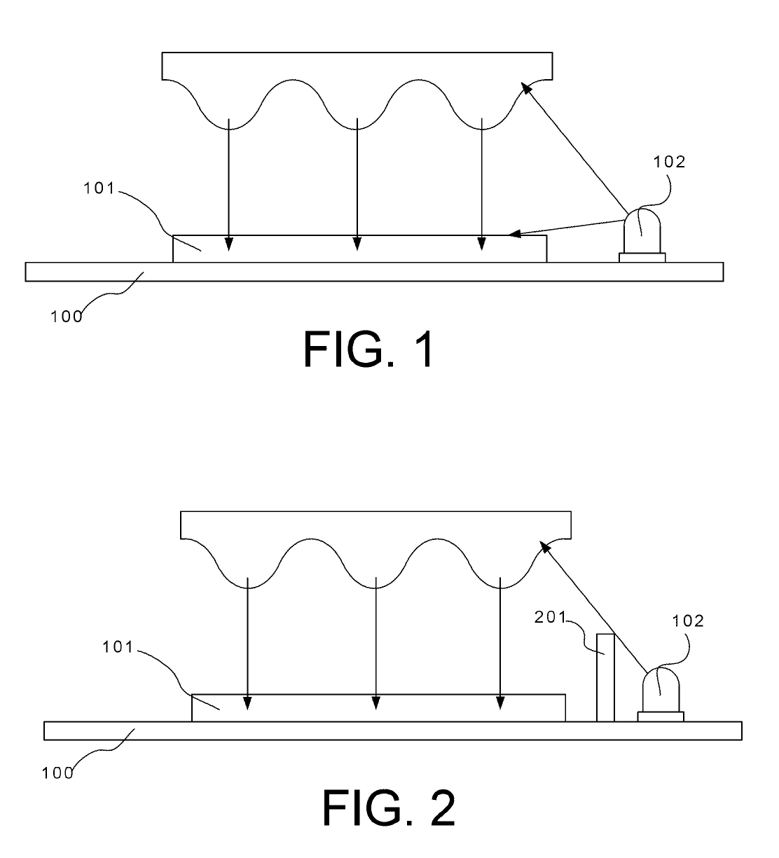

### DETAILED DESCRIPTION OF THE INVENTION

In the embodiments and claims, spatially relative terms, such as “underlying,” “below,” “lower,” “overlying,” “upper” and the like, may be used herein for ease of description to describe one element or feature's relationship to another element(s) or feature(s) as illustrated in the figures. Those skilled in the art may understand that the spatially relative terms are intended to encompass different orientations of the apparatus in use or operation in addition to the orientation depicted in the figures. For example, if an apparatus in the drawing is turned over, elements or features described as “below” or “beneath” other elements or features would then be oriented “above” the other elements. The terms “below” or “beneath” can, therefore, encompass both an orientation of above and below. If the apparatus may be otherwise oriented (rotated 90 degrees or at other orientations), then the spatially relative descriptors used herein may likewise be interpreted accordingly.

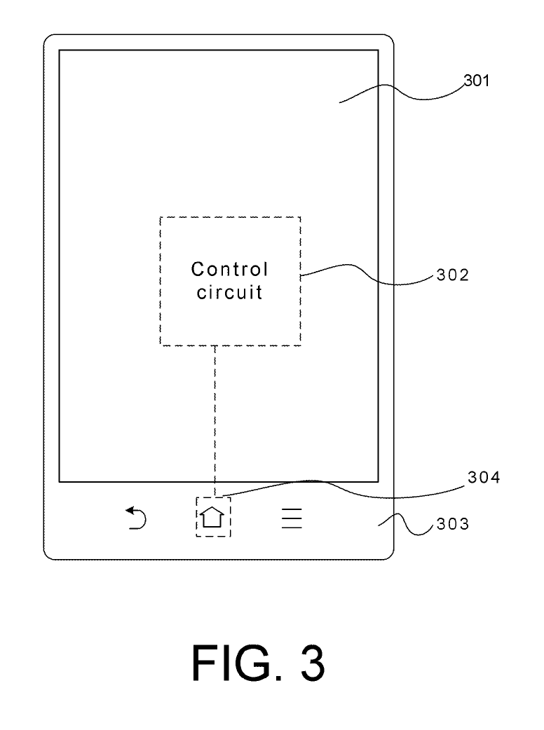

FIG. 3 is a schematic view showing a mobile apparatus according to a preferred embodiment of the invention. Referring to FIG. 3, the mobile apparatus of this embodiment comprises a display panel 301, a control circuit 302, a protective cover layer 303 and a fingerprint detection apparatus 304. In this embodiment, the protective cover layer 303 is disposed above a display panel, and covers the overall mobile apparatus. The fingerprint detection apparatus 304 is disposed below the protective cover layer 303. Generally speaking, if the current smart mobile phone is described as an example, the protective cover layer 303 is implemented by the protective glass. The control circuit 302 electrically connected to the display panel 301 and the fingerprint detection apparatus 304 controls the display panel 301 and the fingerprint detection apparatus 304. In this embodiment, the fingerprint detection apparatus 304 is disposed on the protective cover layer 303 (i.e., below the protective glass). In addition, the fingerprint detection apparatus 304 of this embodiment is disposed below a virtual touch button (HOME).

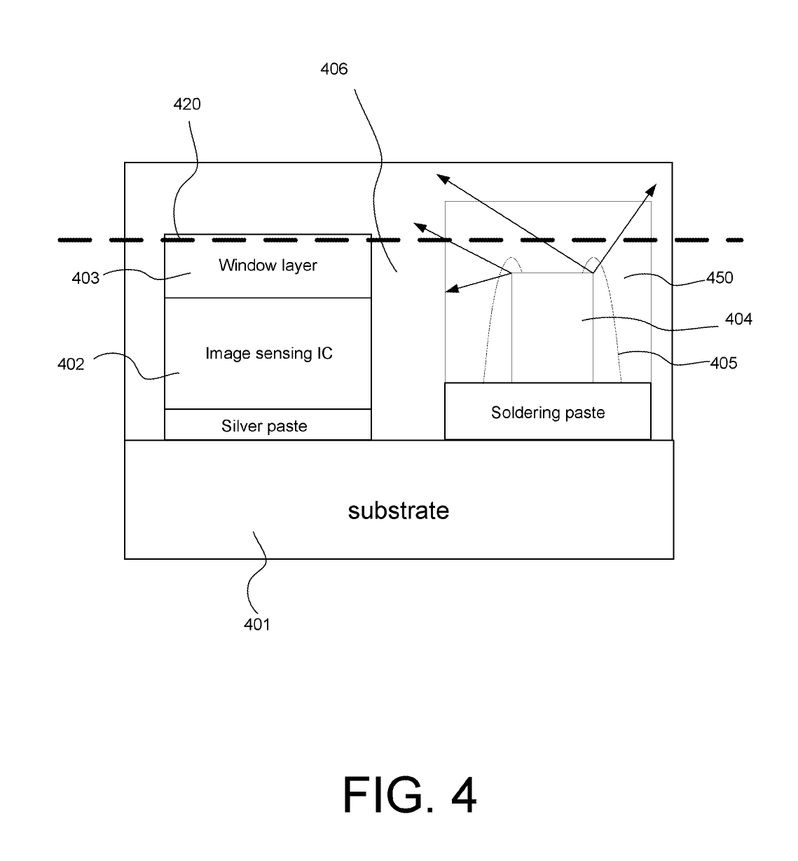

FIG. 4 is a structure diagram showing a fingerprint detection apparatus according to a preferred embodiment of the invention. Referring to FIG. 4, the fingerprint detection apparatus comprises a substrate 401, an image sensing IC 402, a window layer 403, a LED 404, bonding wires 405 and an integrated mold 406. In this embodiment, the image sensing IC 402 and the LED 404 are packaged in the same integrated circuit by way of system in package (SIP). The LED 404 is electrically connected to the substrate 401 through a soldering paste. The image sensing IC 402 is electrically connected to the substrate through a silver paste. The image sensing IC 402 and the LED 404 are electrically connected together through layouts on the substrate. Thus, the image sensing IC 402 can control the LED 404 to emit light and extinguish.

In this embodiment, the window layer 403 is disposed above the image sensing IC 402. The window layer 403 is made of a light-permeable material. Upon the manufacturing of the fingerprint detection apparatus, the last step of grinding and dicing is performed. At this time, the portions above the dashed line 420 are ground out. Thereafter, the window layer 403 is exposed, and a light-permeable material 450 of the LED 404 is also exposed. Those skilled in the art may obtain that such the light barrier of the integrated mold 406 is present between the LED 404 and the window layer 403. Thus, the light, emitted from the LED 404 and having the special wavelength, cannot directly illuminate the sensor cells above the image sensing IC 402. When the finger is disposed above the LED 404 and the window layer 403, the LED 404 illuminates the finger to make the finger emit light to the image sensing IC 402 through the window layer 403. Because the molding material of the integrated mold 406 blocks the light travelling path between the LED 404 and the image sensing IC 402, it is possible to prevent the light, outputted from the LED 404, from directly entering the image sensing IC 402. Thus, the quality of the fingerprint identification can be enhanced.

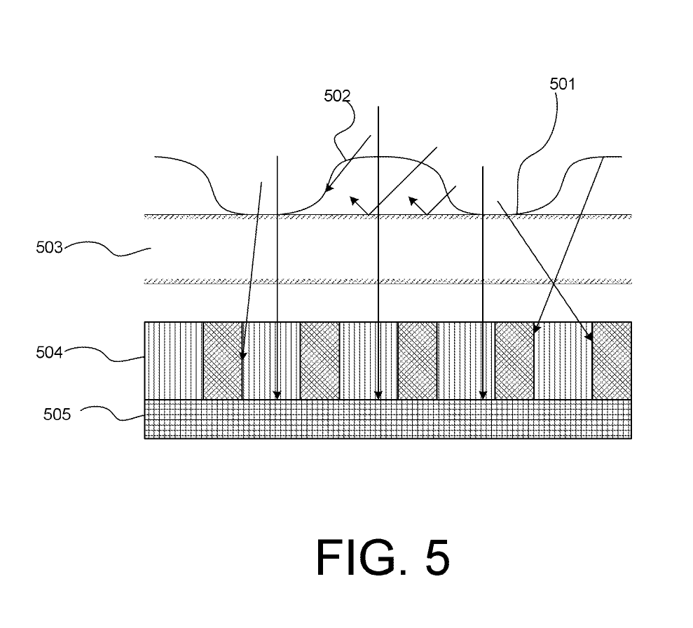

FIG. 5 is a schematic view showing an operation of a fingerprint detection apparatus according to a preferred embodiment of the invention. Referring to FIG. 5, symbol 501 represents the ridge portion of the fingerprint of the finger; symbol 502 represents the valley portion of the fingerprint of the finger; symbol 503 represents the protective glass; symbol 504 represents the window layer; and symbol 505 represents the image sensing IC. In this schematic view, the window layer 504 is implemented in the form of a spatial filter 504, which has the effects of filtering out the scatter light and allows the directly emitted light to enter the image sensing IC. According to this embodiment, it is obtained that the directly emitted light passes through the spatial filter 504 and enters the image sensing IC 505. The scatter light, caused by the valley portion of the fingerprint of the finger, is reflected by the protective glass and blocked or absorbed by the non-light-channel portion of the spatial filter 504, while the scatter light caused by the ridge portion of the fingerprint of the finger is blocked or absorbed by the non-light-channel portion of the spatial filter 504. Thus, the image sensing IC 505 can only receive the light substantially directly entering the image sensing IC 505, and cannot receive the scatter light, so that the image quality of the fingerprint can be enhanced. However, the invention is not restricted to the implementation of the window layer.

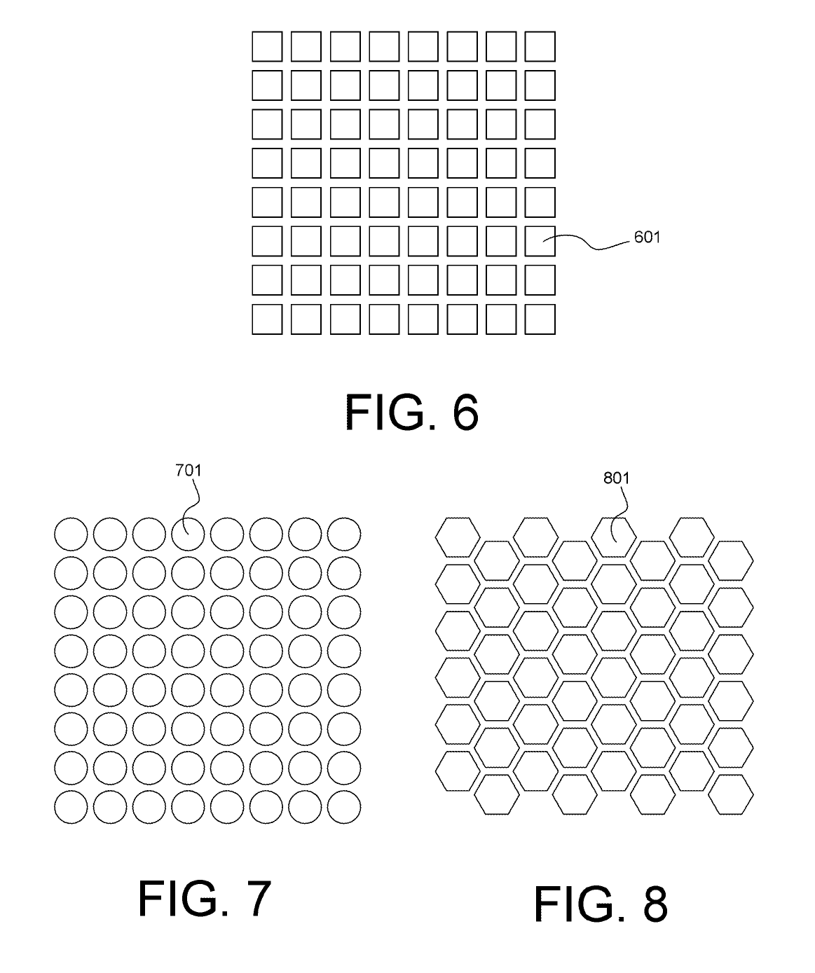

FIG. 6 is a top view showing a spatial filter 504 of fingerprint detection apparatus according to a preferred embodiment of the invention. Referring to FIG. 6, symbol 601 represents the light channel. In this embodiment, the light channel 601 of the spatial filter 504 is square, and the light channels 601 in the overall spatial filter 504 are disposed in a rectangular matrix. FIG. 7 is a top view showing a spatial filter 504 of a fingerprint detection apparatus according to a preferred embodiment of the invention. Referring to FIG. 7, the light channel 701 of the spatial filter 504 of this embodiment is circular, and the light channels 701 in the overall spatial filter 504 are disposed in a rectangular matrix. FIG. 8 is a top view showing a spatial filter 504 of a fingerprint detection apparatus according to a preferred embodiment of the invention. Referring to FIG. 8, the light channel 801 of the spatial filter 504 of this embodiment is hexagonal, and the light channels 801 in the overall spatial filter 504 are arranged in a honeycomb shape. In the embodiment of the invention, although the fingerprint detection apparatus 304 is disposed below the virtual touch button, for example, those skilled in the art should know that the arranged position of the fingerprint detection apparatus 304 may be determined according to the design of the product designer upon the practical application of the invention, so the invention is not restricted thereto.

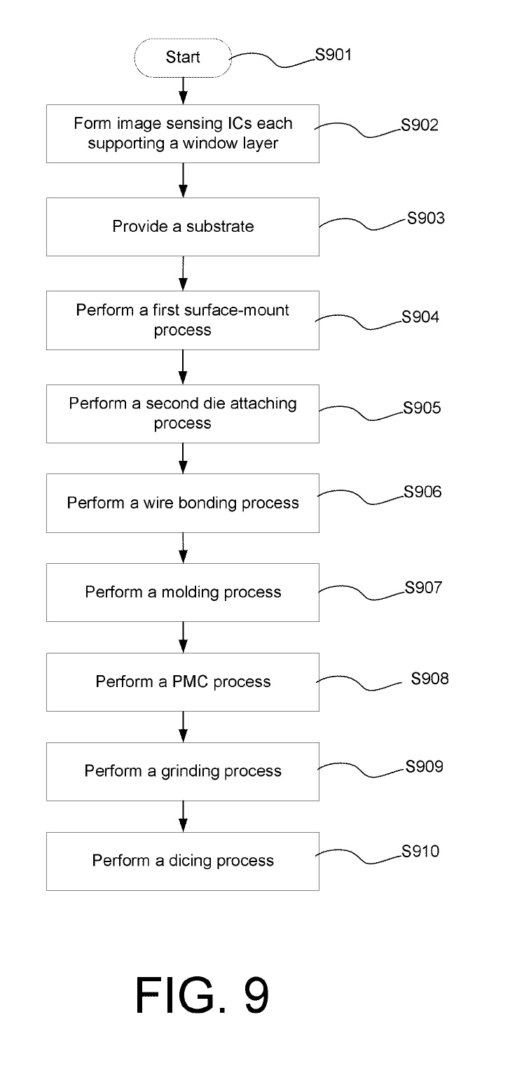

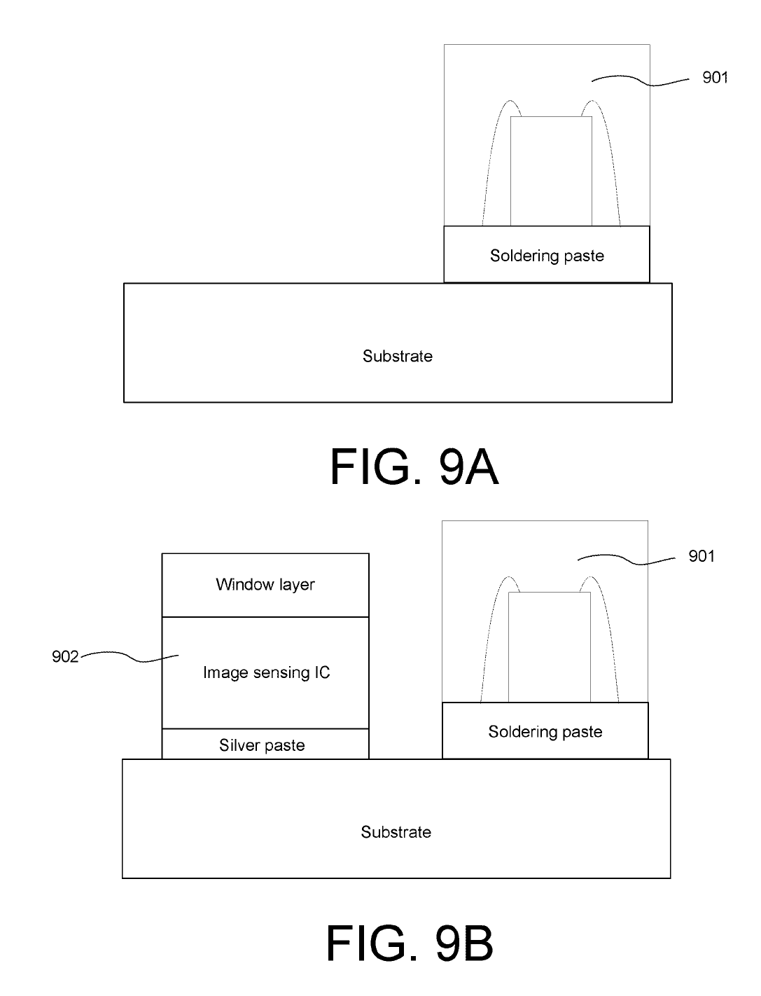

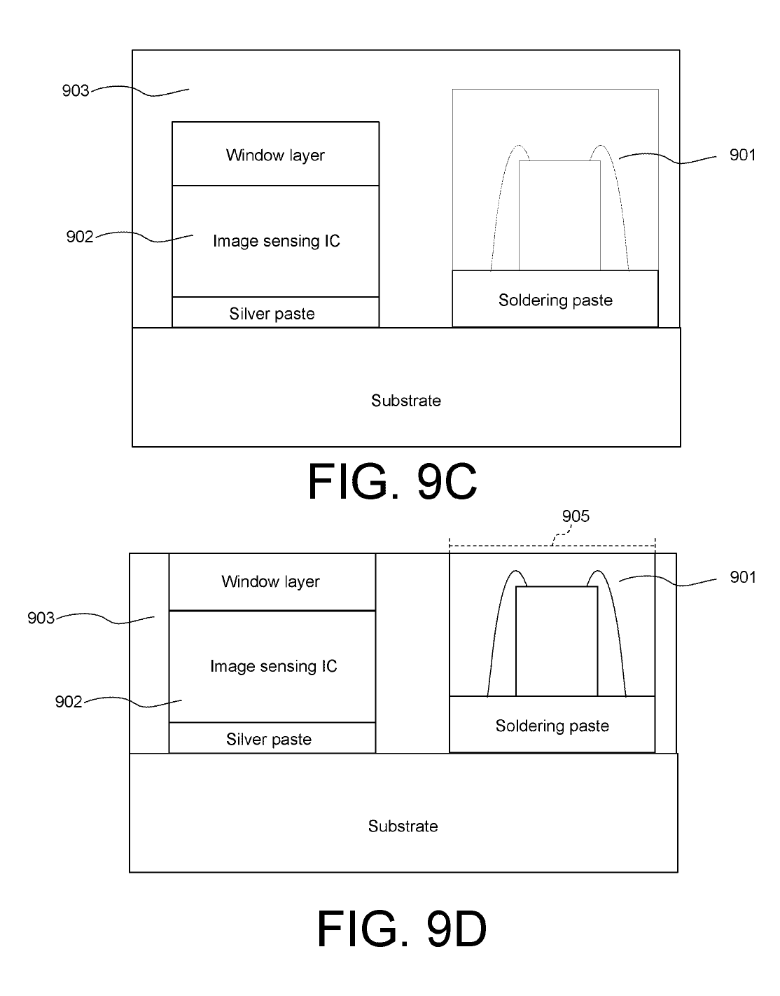

In order to make those skilled in the art implement the invention through this embodiment, a manufacturing method of the fingerprint detection apparatus of this embodiment will be described as an example. FIG. 9 is a flow chart showing a manufacturing method of a fingerprint detection apparatus according to a preferred embodiment of the invention. Referring to FIG. 9, the manufacturing method of the fingerprint detection apparatus comprises the following steps.

In step S901, the manufacturing method of the fingerprint detection apparatus starts.

In step S902, image sensing ICs, which respectively have a window layer, are formed.

In step S903, a substrate, such as a printed circuit board (PCB), is provided.

In step S904, a first surface-mount process is performed on light emitting elements. The light emitting element may be, for example, a visible light LED die, an infrared LED die or the like. FIG. 9A is a schematic view showing the step S904 of the manufacturing method of the fingerprint detection apparatus according to a preferred embodiment of the invention. Referring to FIG. 9A, it is obtained that a LED die 901 is attached to the substrate through the soldering paste.

In step S905, a second die attaching process is performed on the image sensing ICs, which respectively have a window layer. FIG. 9B is a schematic view showing the step S905 of the manufacturing method of the fingerprint detection apparatus according to a preferred embodiment of the invention. Referring to FIG. 9B, it is obtained that an image sensing IC 902 supporting the window layer is attached to the substrate through the silver paste.

In step S906, a wire bonding process is performed on the image sensing ICs, which respectively have the window layer.

In step S907, a molding process is performed. FIG. 9C is a schematic view showing the step S907 of the manufacturing method of the fingerprint detection apparatus according to a preferred embodiment of the invention. Referring to FIG. 9C, it is obtained that a molding material 903, such as epoxy resin, is used to mold the image sensing IC 902 supporting the window layer, and the LED die 901 (light emitting element) into the same one circuit package.

In step S908, an post mold curing process is performed to cure the molding material.

In step S909, a grinding process is performed. FIG. 9D is a schematic view showing the step S909 of the manufacturing method of the fingerprint detection apparatus according to a preferred embodiment of the invention. Referring to FIG. 9D, the excess molding material is ground out to expose the window layer, and a light-permeable window 905 of the light emitting element is opened.

In step S910, a dicing process is performed to form independent fingerprint detection apparatuses. In FIGS. 9A to 9D, only one single image sensing IC and one single light emitting element are depicted. When the fingerprint detection apparatus is manufactured in practice, multiple image sensing ICs and multiple light emitting elements are disposed on the same substrate, and are attached in an array. After the package is finished, the dicing process is performed.

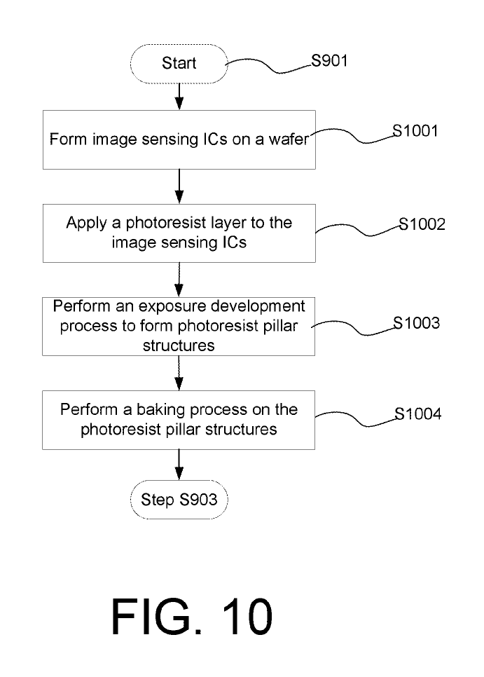

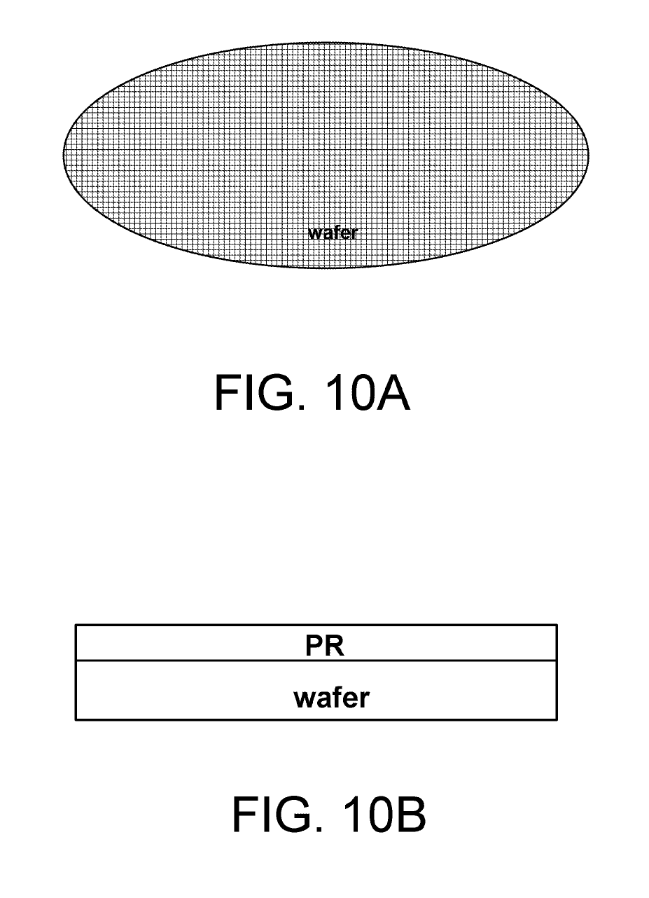

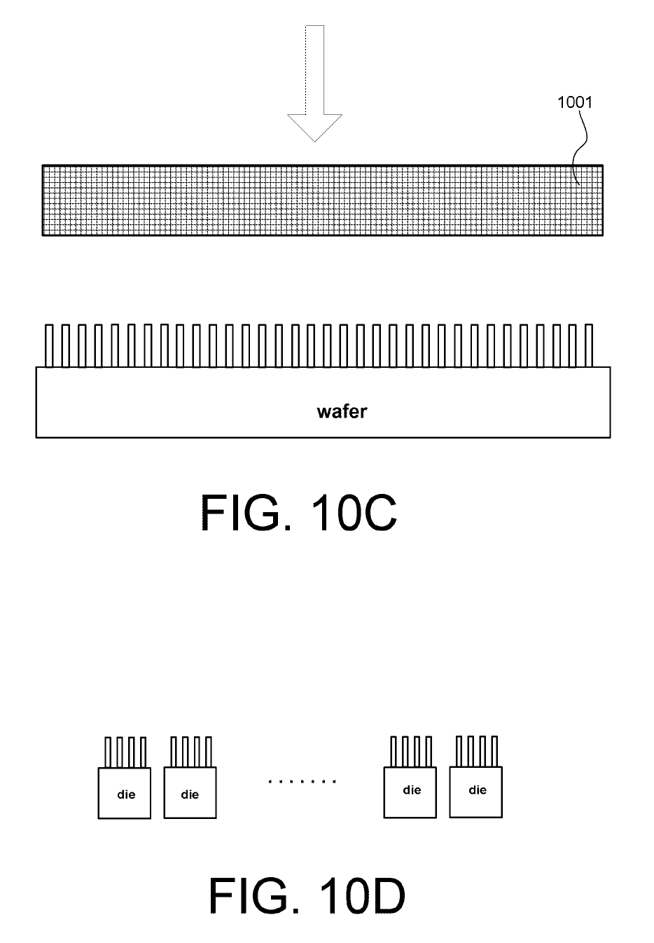

FIG. 10 is a detailed flow chart showing the step S901 of the manufacturing method of the fingerprint detection apparatus according to a preferred embodiment of the invention. Referring to FIG. 10, the step S901 of forming the image sensing ICs, which respectively have a window layer, in the above-mentioned embodiment may comprise the following sub-steps.

In step S1001, multiple image sensing ICs are formed on a wafer, as shown in FIG. 10A, which is a schematic view showing the step S1001 of the manufacturing method of the fingerprint detection apparatus according to a preferred embodiment of the invention.

In step S1002, a photoresist layer is applied to the image sensing ICs, as shown in FIG. 10B, which is a schematic view showing the step S1002 of the manufacturing method of the fingerprint detection apparatus according to a preferred embodiment of the invention.

In step S1003, an exposure development process is performed to form multiple photoresist pillar structures on the image sensing ICs, as shown in FIG. 10C, which is a schematic view showing the step S1003 of the manufacturing method of the fingerprint detection apparatus according to a preferred embodiment of the invention. Referring to FIG. 10C, the exposure development process of this embodiment is performed using a mask 1001 to make the photoresist layer become photoresist pillar structures.

In step S1004, a baking process is performed on the photoresist pillar structures to cure the photoresist pillar structures.

In step S1005, the wafer is diced to obtain the image sensing ICs having photoresist pillar structures, as shown in FIG. 10D, which is a schematic view showing the step S1005 of the manufacturing method of the fingerprint detection apparatus according to a preferred embodiment of the invention. Thereafter, the grid-like spatial filter, as shown in FIG. 5, 6, 7 or 8 can be formed through the molding process of the step S907 and the post mold curing process of the step S908.

Those skilled in the art should know that the spatial filter is a preferred way of implementation. Because the spatial filter can absorb the light, which does not directly enter the image sensing IC, the scatter light can be eliminated. However, the objective of the invention is to stop the light, outputted from the light emitting element (LED 404), from directly entering the image sensing IC. So, only the formation of a full window layer without the formation of the spatial filter also falls within the scope of the invention. So, the invention is not restricted thereto.

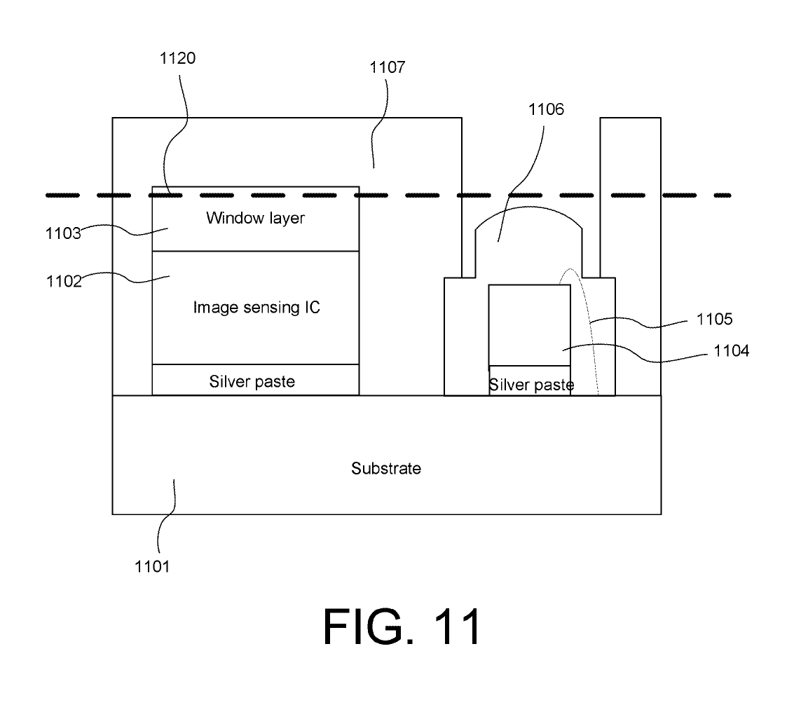

FIG. 11 is a structure diagram showing a fingerprint detection apparatus according to a preferred embodiment of the invention. Referring to FIG. 11, the fingerprint detection apparatus includes a substrate 1101, a image sensing IC 1102, a window layer 1103, an LED die 1104, bounding wire 1105, a first mold 1106 and a second mold 1107. In this embodiment, the image sensing IC 1102 and the LED 1104 is packaged in the same IC by the double molding. The LED 1104 is electrically connected to the substrate 1101 through the silver paste and bounding wire. And the image sensing IC 1102 is also electrically connected to the substrate through the silver paste. The image sensing IC 1102 and the LED 1104 are electrically connected to each other by the layout of the substrate 1101. Thus, the image sensing IC 1102 can electrically control on, off or luminance of the LED 1104.

In this embodiment, a window layer 1103 is disposed on the image sensing IC 1102. The window layer 1103 is made of light-permeable material. In the manufacturing process of the fingerprint detection apparatus, one of step would perform the grinding process and dicing process. At this step, the upper part of the dashed line 1120 would be ground. After that, the window layer 1103 would be exposed. Because the double molding is adopted in this embodiment, the LED 1104 does not cover any epoxy for the image sensing IC 1102. People having ordinary skill in the art should know that there is a second mold 1107 between the LED 1104 and the window layer 1103 to serve as light barrier, wherein the second mold 1107 is a opaque molding material, which is epoxy in general. Thus, a specific wavelength light emitting from the LED 1104 would not directly emit to the sensor cells on the image sensing IC 1102.

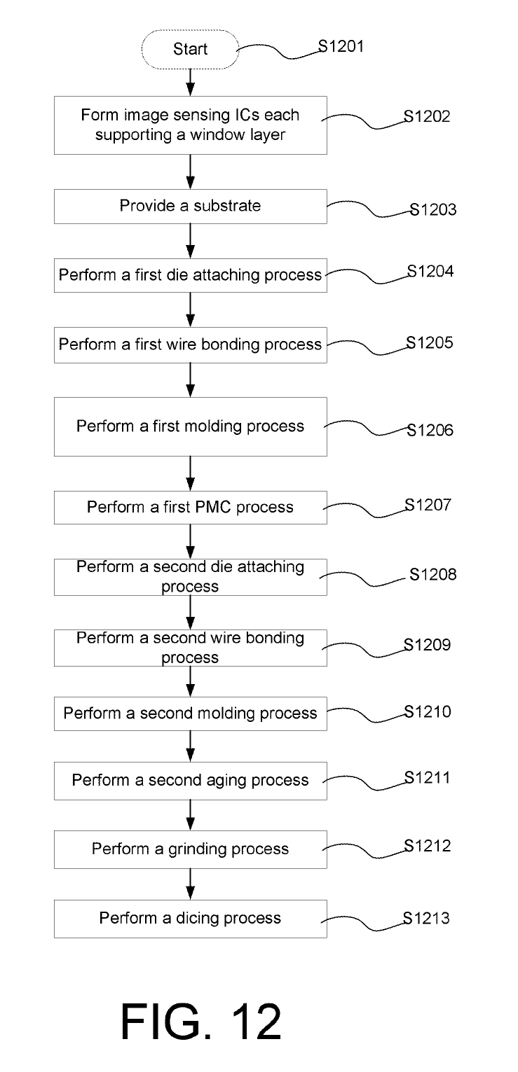

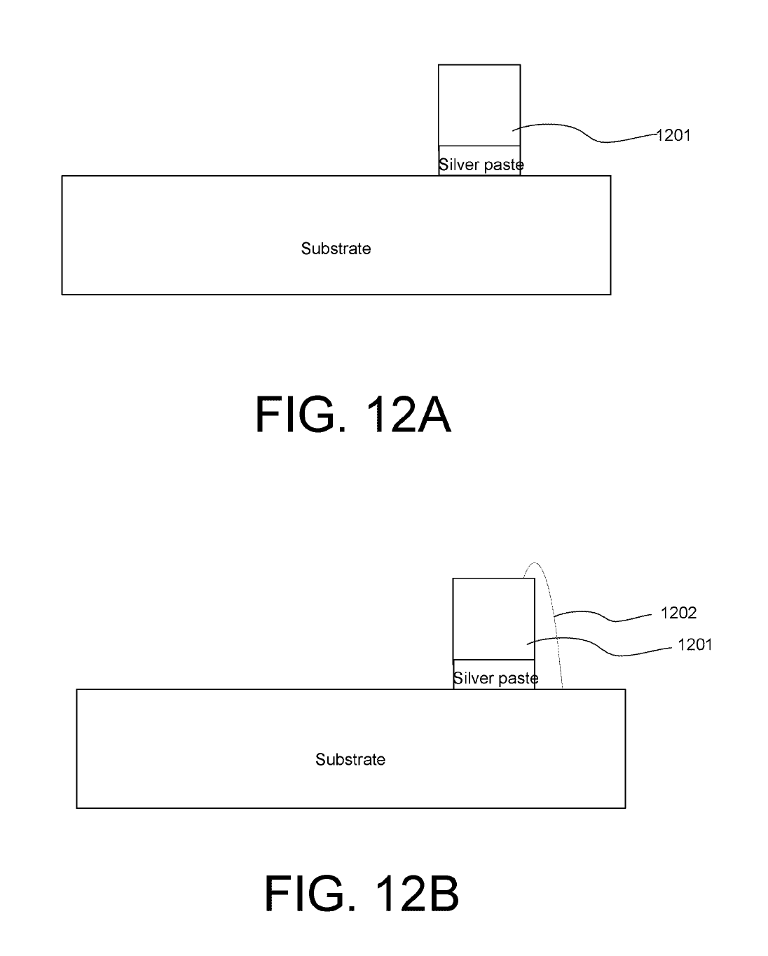

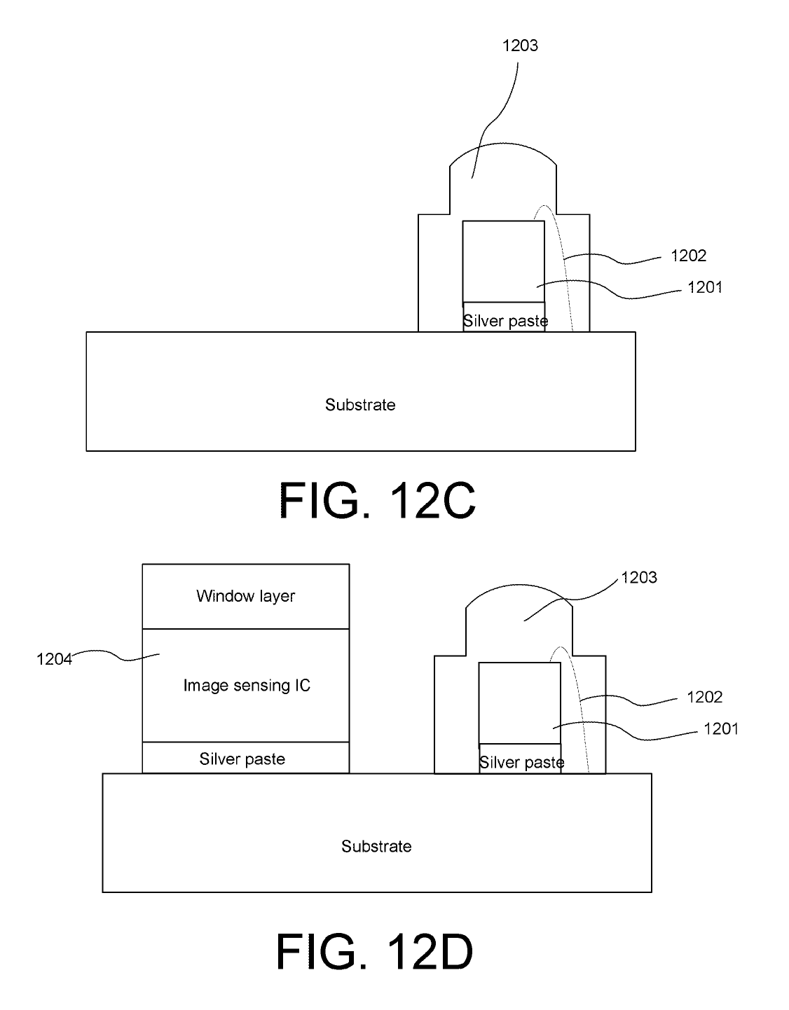

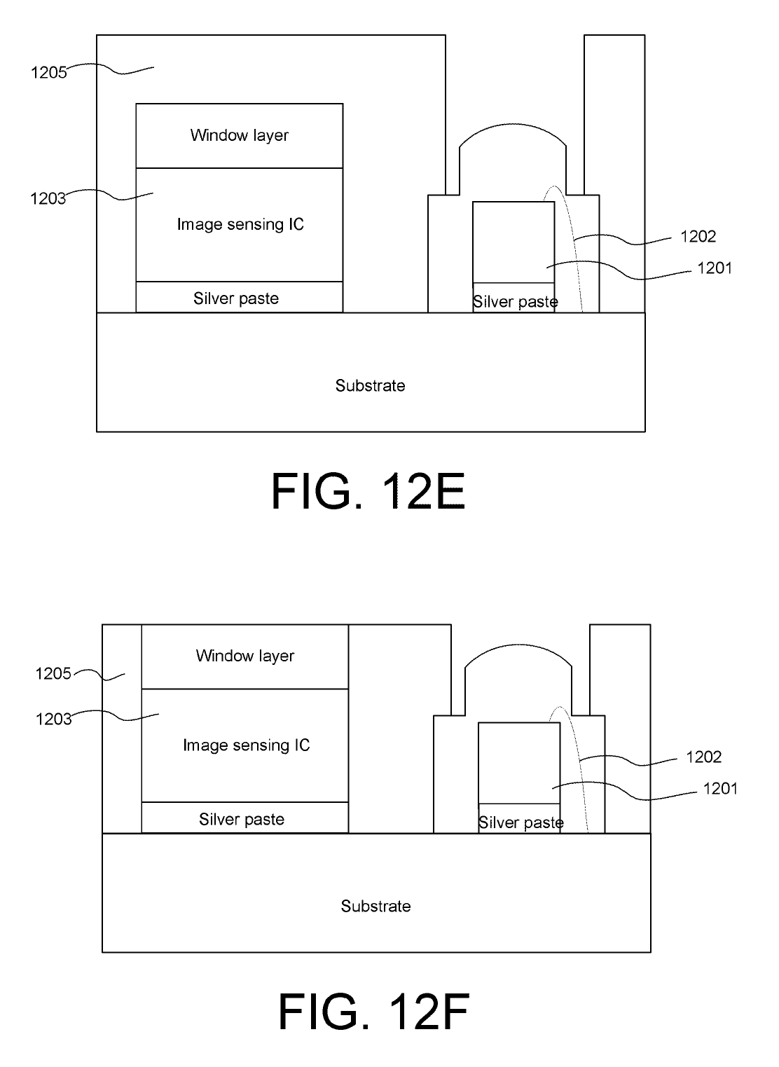

FIG. 12 is a flow chart showing a manufacturing method of a fingerprint detection apparatus according to a preferred embodiment of the invention. Referring to FIG. 12, the manufacturing method of a fingerprint detection apparatus includes the following steps.

In the step S1201: the method starts

In step S1202, image sensing ICs, which respectively have a window layer, are formed. The manufacturing method may be referred to FIG. 10, but it is not restricted to FIG. 10. Further, the structure is also not restricted to FIGS. 10A-10D.

In step S1203, a substrate, such as a printed circuit board (PCB), is provided.

In step S1204, a first die attaching process is performed on light emitting elements. The light emitting element may be, for example, a visible light LED die, an infrared LED die or the like. Referring to FIG. 12A, FIG. 12A is a schematic view showing a step S1204 of the manufacturing method of the fingerprint detection apparatus according to a preferred embodiment of the invention. As shown in FIG. 12, the LED die 1201 is attached on the substrate through the soldering paste.

In step S1205, a first wire bounding process is performed on the light emitting elements 1201. Referring to FIG. 12B, FIG. 12B is a schematic view showing a step S1205 of the manufacturing method of the fingerprint detection apparatus according to a preferred embodiment of the invention. As shown in FIG. 12B, the LED die 1201 is electrically connected to the substrate through the bounding wire 1202.

In step S1206, a first molding process is performed. Referring to FIG. 12C, FIG. 12C is a schematic view showing a step S1206 of the manufacturing method of the fingerprint detection apparatus according to a preferred embodiment of the invention. As shown in FIG. 12C, the LED die 1201 and the bounding wire 1202 are packaged into the first molding material 1203 through the first molding process.

In step S1207, a first post mold curing (PMC) is performed.

In step S1208, a second die attaching process is performed on the image sensing ICs, which respective have a window layer. Referring to FIG. 12D, FIG. 12D is a schematic view showing a step S1208 of the manufacturing method of the fingerprint detection apparatus according to a preferred embodiment of the invention. As shown in FIG. 12D, the image sensing IC 1204 with window layer is attached on the substrate through the silver paste.

In step S1209, a second wire bounding process is performed on the image sensing ICs, which respective have the window layer.

In step S1210, a second molding process is performed. Referring to FIG. 12E, FIG. 12E is a schematic view showing a step S1210 of the manufacturing method of the fingerprint detection apparatus according to a preferred embodiment of the invention. As shown in FIG. 12E, the second molding material 1205, such as epoxy, is adopted to package the LED and the image sensing IC with the window layer.

In step S1211, a second PMC is performed. The second PMC is used for fixing the second molding material which is for packaging the image sensing IC with the window layer.

In step S1212, a grinding process is performed. Referring to FIG. 12F, FIG. 12F is a schematic view showing a step S1212 of the manufacturing method of the fingerprint detection apparatus according to a preferred embodiment of the invention. As shown in FIG. 12F, a excess molding material is grounded such that the window layer is revealed.

In step S1213, a dicing process is performed to form independent fingerprint detection apparatuses. In FIGS. 12A to 12F, only one single image sensing IC and one single light emitting element are depicted. When the fingerprint detection apparatus is manufactured in practice, multiple image sensing ICs and multiple light emitting elements are disposed on the same substrate, and are attached in an array. After the package is finished, the dicing process is performed.

In the abovementioned embodiment, the order of the steps may be shown as above. However, in practice, the order may be: step S1204 (first die attaching), step S1208 (second die attaching), step S1205 (first wire bounding), step S1209 (second wire bounding), step S1206 (first molding), step S1207 (first PMC), step S1210 (second molding), step S1211 (second PMC). The order of the steps may be changed according to the different IC package machines. Thus, the present invention is not limited thereto.

In summary, the essence of the invention is to dispose one window layer above the image sensing IC for fingerprint identification. The window layer can allow the light to pass through. Then, the light emitting circuit and the image sensing IC for fingerprint identification are packaged into the same integrated circuit. And thus, the light emitting circuit and the image sensing IC for fingerprint identification are integrated in the same IC. Because the molding material surrounds the image sensing IC for fingerprint identification upon packaging, a natural light barrier is formed between the image sensing IC and the light emitting circuit. Thus, it is possible to prevent the light of the light emitting circuit from directly entering the image sensing IC for fingerprint identification, so that the read fingerprint becomes clearer.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A fingerprint detection apparatus, comprising:
a substrate;
an image sensing IC disposed on the substrate;
a light emitting circuit, which is disposed on the substrate and on one side of the image sensing IC and electrically connected to the image sensing IC;
a window layer disposed on the image sensing IC, wherein light can pass through the window layer and enter the image sensing IC; and
a molding material surrounding the image sensing IC and the window layer, wherein the molding material blocks a light travelling path between the light emitting circuit and the image sensing IC to prevent light, emitted directly from the light emitting circuit, from entering the image sensing IC and to enhance a quality of fingerprint identification.

2. The fingerprint detection apparatus according to claim 1, wherein the window layer comprises:
a spatial filter disposed on the image sensing IC, wherein the spatial filter has multiple neighboring light channels, which restrict an angle of light entering the image sensing IC to prevent scatter light from entering the image sensing IC.

3. The fingerprint detection apparatus according to claim 1, wherein the light emitting circuit comprises:
a specific light source emitting circuit disposed on one side of the image sensing IC and electrically connected to the image sensing IC.

4. The fingerprint detection apparatus according to claim 1, wherein the light emitting circuit comprises:
a visible light emitting circuit disposed on one side of the image sensing IC and electrically connected to the image sensing IC,
wherein when the fingerprint identification is performed, the visible light emitting circuit emits visible light to make a user obtain a placement position of a finger through the visible light.

5. The fingerprint detection apparatus according to claim 2, wherein the light channels of the spatial filter constitute a two-dimensional array.

6. The fingerprint detection apparatus according to claim 1,
wherein the fingerprint detection apparatus is packaged by way of system in package (SIP),
wherein the image sensing IC is attached to the substrate by a silver paste, and the light emitting circuit is attached to the substrate by a soldering paste;
wherein the molding material of the fingerprint detection apparatus comprises:
an epoxy resin covering the image sensing IC, the light emitting circuit and the window layer through a molding process,
wherein the window layer and a light-permeable material of the light emitting circuit are exposed through a grinding process, so that when the light emitting circuit is turned on, light can be emitted from a ground surface of the light emitting circuit, and the image sensing IC receives light from a finger through a ground surface of the window layer.

7. The fingerprint detection apparatus according to claim 1, wherein the fingerprint detection apparatus is packaged by way of double molding,
wherein the image sensing IC is attached to the substrate using a first silver paste;
wherein the light emitting circuit is attached to the substrate using a second silver paste;
wherein the fingerprint detection apparatus further comprises, on the light emitting circuit, a light-permeable mold covering the light emitting circuit;
wherein the molding material of the fingerprint detection apparatus comprises: an epoxy resin covering the image sensing IC and the window layer through a molding process,
wherein the window layer is exposed through a grinding process, so that when the light emitting circuit is turned on, light emitted from the light emitting circuit is emitted through the finger and received by the image sensing IC through a ground surface of the window layer.

8. A mobile device, comprising:
a control circuit;
a display panel, electrically connected to the control circuit;
a protective cover, disposed on the display panel; and
a fingerprint detection apparatus, comprising:
a substrate;
an image sensing IC disposed on the substrate;
a light emitting circuit, which is disposed on the substrate and on one side of the image sensing IC and electrically connected to the image sensing IC;
a window layer disposed on the image sensing IC, wherein light can pass through the window layer and enter the image sensing IC; and
a molding material surrounding the image sensing IC and the window layer, wherein the molding material blocks a light travelling path between the light emitting circuit and the image sensing IC to prevent light, emitted directly from the light emitting circuit, from entering the image sensing IC and to enhance a quality of fingerprint identification.

9. The mobile device according to claim 8, wherein the window layer comprises:
a spatial filter disposed on the image sensing IC, wherein the spatial filter has multiple neighboring light channels, which restrict an angle of light entering the image sensing IC to prevent scatter light from entering the image sensing IC.

10. The mobile device according to claim 8, wherein the light emitting circuit comprises:
a specific light source emitting circuit disposed on one side of the image sensing IC and electrically connected to the image sensing IC.

11. The mobile device according to claim 8, wherein the light emitting circuit comprises:
a visible light emitting circuit disposed on one side of the image sensing IC and electrically connected to the image sensing IC,
wherein when the fingerprint identification is performed, the visible light emitting circuit emits visible light to make a user obtain a placement position of a finger through the visible light.

12. The mobile device according to claim 9, wherein the light channels of the spatial filter constitute a two-dimensional array.

13. The mobile device according to claim 8,
wherein the fingerprint detection apparatus is packaged by way of system in package (SIP),
wherein the image sensing IC is attached to the substrate by a silver paste, and the light emitting circuit is attached to the substrate by a soldering paste;
wherein the molding material of the fingerprint detection apparatus comprises:
an epoxy resin covering the image sensing IC, the light emitting circuit and the window layer through a molding process,
wherein the window layer and a light-permeable material of the light emitting circuit are exposed through a grinding process, so that when the light emitting circuit is turned on, light can be emitted from a ground surface of the light emitting circuit, and the image sensing IC receives light from a finger through a ground surface of the window layer.

14. The mobile device according to claim 8, wherein the fingerprint detection apparatus is packaged by way of double molding,
wherein the image sensing IC is attached to the substrate using a first silver paste;
wherein the light emitting circuit is attached to the substrate using a second silver paste;
wherein the fingerprint detection apparatus further comprises, on the light emitting circuit, a light-permeable mold covering the light emitting circuit;
wherein the molding material of the fingerprint detection apparatus comprises: an epoxy resin covering the image sensing IC and the window layer through a molding process,
wherein the window layer is exposed through a grinding process, so that when the light emitting circuit is turned on, light emitted from the light emitting circuit is emitted through the finger and received by the image sensing IC through a ground surface of the window layer.

15. A method of manufacturing a fingerprint detection apparatus, comprising:
providing a substrate;
performing a first surface-mount process on light emitting elements;
performing a second die attaching process on image sensing ICs which respectively have a window layer, wherein the window layer is disposed on the image sensing IC, wherein light passes through the window layer and enters the image sensing IC;
performing a wire bonding process on the image sensing ICs which respectively have the window layer;
performing a molding process on the image sensing ICs which respectively have the window layer and the light emitting elements;
performing an post mold curing process;
performing a grinding process; and
performing a dicing process to form independent fingerprint detection apparatuses.

16. The manufacturing method according to claim 15, wherein forming the image sensing ICs which respectively have the window layer comprises:
forming the image sensing ICs on a wafer;
forming the window layer on the image sensing ICs using a photoresist; and
dicing the wafer to obtain the image sensing ICs which respectively have the window layer.

17. The manufacturing method according to claim 16, wherein forming the window layer on the image sensing ICs using the photoresist comprises:
applying a photoresist layer to the image sensing ICs;
performing an exposure development process to form photoresist pillar structures on the image sensing ICs; and
performing a baking process on the photoresist pillar structures.

18. A method of manufacturing a fingerprint detection apparatus, comprising:
providing a substrate;
performing a first die attaching process on light emitting elements;
performing a first wire bonding process on the light emitting elements;
performing a first molding process on the light emitting elements;
performing a first mold curing process;
performing a second die attaching process on image sensing ICs which respectively have a window layer, wherein the window layer is disposed on the image sensing IC, wherein light passes through the window layer and enters the image sensing IC;
performing a second wire bonding process on the image sensing ICs which respectively have the window layer;
performing a second molding process on the image sensing ICs which respectively have the window layer and the light emitting elements;
performing an post mold curing process;
performing a grinding process; and
performing a dicing process to form independent fingerprint detection apparatuses.

19. The manufacturing method according to claim 18, wherein forming the image sensing ICs which respectively have the window layer comprises:
forming the image sensing ICs on a wafer;
forming the window layer on the image sensing ICs using a photoresist; and
dicing the wafer to obtain the image sensing ICs which respectively have the window layer.

20. The manufacturing method according to claim 18, wherein forming the window layer on the image sensing ICs using the photoresist comprises:
applying a photoresist layer to the image sensing ICs;
performing an exposure development process to form photoresist pillar structures on the image sensing ICs; and
performing a baking process on the photoresist pillar structures.
